(19) United States
(12) Patent Application Publication
(10) Pub. No.: US 2022/0341577 A1
(43) Pub. Date: Oct. 27, 2022

(54) LED LAMP FOR LIGHTING WITH RADIO CONTROL

(71) Applicant: CYNERGI S.R.L., Milano (IT)

(72) Inventor: Sandro TOFFOLETTO, (US)

(21) Appl. No.: 17/754,472

(22) PCT Filed: Oct. 2, 2020
(86) PCT No.: PCT/IB2020/059239

§ 371 Date: Apr. 1, 2022

(30) Foreign Application Priority Data
Oct. 4, 2019 (IT) 102019000017960

(51) Int. Cl. F21V 23/04; F21S 8/08; F21V 15/01

(52) U.S. Cl. CPC F21V 23/045; F21S 8/086; F21V 15/01; F21Y 2115/10

(57) ABSTRACT

It is disclosed a lamp for public, industrial or commercial lighting, with radio control. The lamp comprises a casing provided with an opening, a protection screen and a printed circuit board housed entirely inside the casing. The board comprises a printed circuit board comprising a mounting surface on which are mounted at least one light beam source, a processing unit, a transceiver of wireless signals connected to the processing unit, an antenna connected to the transceiver and a power supply circuit.

### BACKGROUND

### Technical Field

The present disclosure generally relates to the field of lamps for industrial, commercial and public illumination, for example road lighting.

More in particular, the present disclosure relates to a LED lamp equipped with radio control, which integrates, on a same board, the LEDs, the power supply system, the radio transceiver and the antenna.

### Description of the Related Art

Smart lamps are known for lighting using LED technology, equipped with telecontrol systems.

Smart lamps of known type comprise a casing inside which the LEDs and the power supply circuit of the LEDs are positioned, so as to be protected by atmospheric agents.

Smart lamps further comprise a radio transceiver which allows the lamp to connect via radio with the other surrounding lamps and with a local or remote control centre: in this way it is possible to suitably vary the light intensity of the LEDs of the lamp in such a way as to optimise energy consumption and lighting needs in a determined area.

The radio transceiver can be mounted inside or outside the casing of the lamp.

The antenna is mounted on the outside of the body of the lamp, so as to guarantee a sufficient quality of the transmitted and received radio signal, but this creates the drawback that the antenna is exposed to atmospheric agents, with the risk that it will be damaged, thus reducing the working life of the whole lamp.

Further, the position of the antenna outside the body of the lamp worsens the aesthetic appearance of the lamp.

### BRIEF SUMMARY

The present disclosure relates to a LED lamp for indoor or outdoor lighting as defined in the appended claims.

The Applicant has perceived that the LED lamp for lighting according to the present disclosure has the following advantages:
it increases the reliability of the lamp (i.e. it increases the working life thereof);
it reduces the number of components of the lamp and facilitates the mounting thereof during its production, thus reducing mounting errors;
it avoids openings, fittings, seals or whatever else is necessary for the fixing of the antenna or the fitting of additional external modules (NEMA, ZHAGA etc.);
it allows transmitting/receiving radio signals from any angular spatial direction on the horizontal plane;
it is less expensive;
it has a more attractive outer appearance.

One embodiment of the present disclosure relates to a lighting system as defined in the appended claims.

### BRIEF DESCRIPTION OF THE SEVERAL VIEWS OF THE DRAWINGS

Additional features and advantages of the disclosure will become more apparent from the description which follows of a preferred embodiment and the variants thereof, provided by way of example with reference to the appended drawings, in which:

FIG. 1 is a perspective view of a lamp for road lighting according to the disclosure;

FIG. 2 shows a block diagram of the lamp according to the disclosure;

FIG. 3 shows a printed circuit board on which the electronic components of the lamp of the disclosure are mounted;

FIGS. 4A-4C show three frontal perspective views of an integrated antenna inside the lamp according to the disclosure;

FIG. 4D is a perspective lateral view of the integrated antenna of the disclosure;

FIG. 4E is a perspective rear view of the integrated antenna of the disclosure;

FIG. 4F is a plan top view of the integrated antenna of the disclosure;

FIGS. 4G and 4H show a frontal plan view and a rear plan view of the integrated antenna of the disclosure, respectively;

FIGS. 5A-5C show three sections of the radiation diagram of the antenna integrated in the lamp of the disclosure.

### DETAILED DESCRIPTION

It should be observed that in the following description, identical or analogous blocks, components or modules are indicated in the figures with the same numerical references, even where they are illustrated in different embodiments of the disclosure.

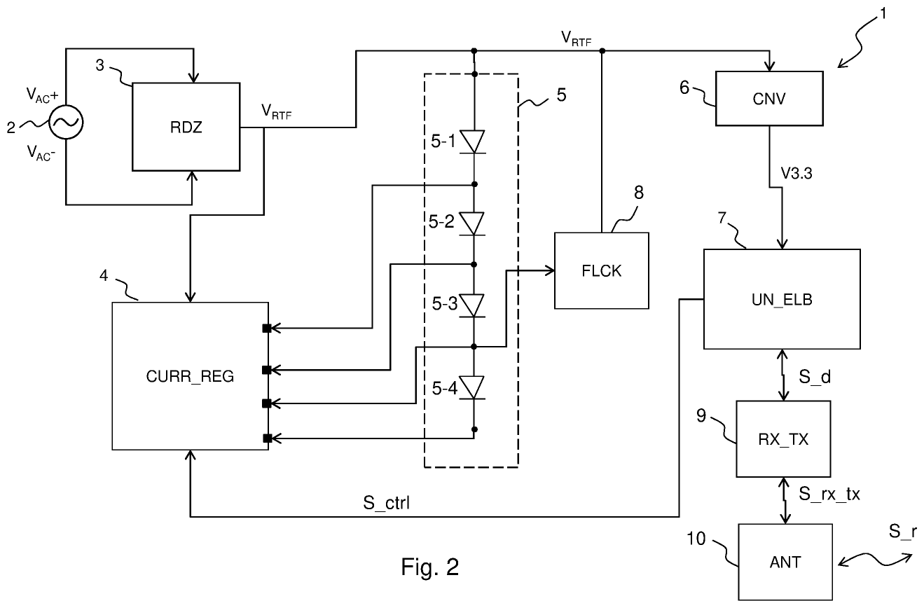

With reference to FIG. 2, a block diagram of a lamp 1 for road lighting according to the disclosure is shown.

The lamp 1 comprises:
a rectifier 3;
a current regulator 4 (in particular of the direct drive type);
a LED string 5;
an anti-flicker circuit 8;
a voltage converter 6;
a processing unit 7;
a transceiver 9;
an antenna 10.

The above-described components are closed inside a casing of the lamp 1.

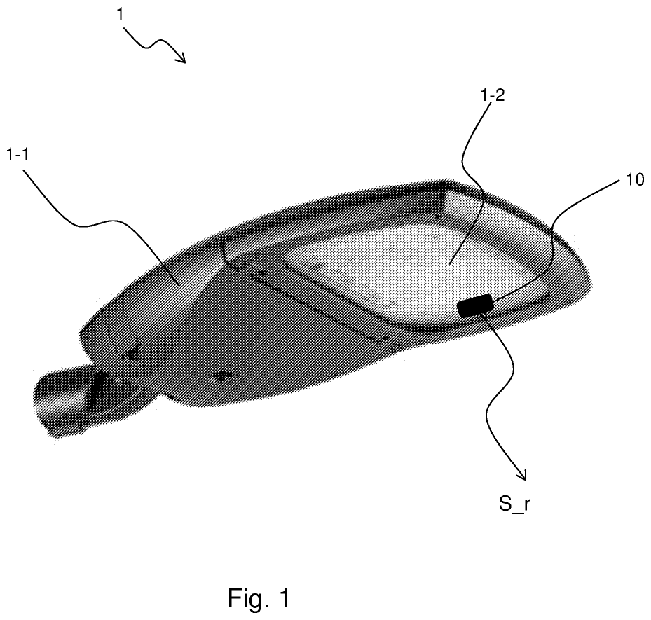

With reference to FIG. 1, it shows a lamp 1 mounted on the upper end of a post fixed for example to the edge of a road surface or a pavement, in order to light the road surface and/or the pavement.

The casing of the lamp 1 comprises a metallic body 1-1 (for example aluminium) and further comprises an opening which allows the passage of the light beam generated by the LED string 5 and of the radio signal transmitted/received by the antenna 10.

The casing of the lamp 1 further comprises a protection screen 1-2 at least partially transparent with respect to the light beam (for example made of a glass or plastic material), wherein said screen 1-2 is mounted in the opening in such a way as to occupy the whole surface defined by the opening: in this way the electronic components mounted inside the lamp 1 (in particular the LED string 5) are protected from atmospheric agents and further the light beam generated by the LED string 5 is able to illuminate the surrounding environment in which the lamp 1 is mounted.

The antenna 10 is mounted on the printed circuit board 20 positioned inside the metallic body 1-1 of the housing so that the antenna 10 is electrically isolated from the metallic body of the casing of the lamp 1 and is positioned in proximity of the opening of the body of the casing itself (and therefore the antenna is positioned in proximity of the protection screen 1-2), as shown in FIG. 2: in this way the electromagnetic wave generated/received by the antenna 10 is able to cross the protection screen 1-2 with a sufficient intensity to be received up to a distance of about 150/200 metres from the lamp on which the antenna 10 is mounted.

Advantageously, the antenna 10 is mounted on a portion of the protection screen 1-2, in particular on a central portion of the protection screen 1-2.

The term “LED string” is intended to mean a series connection of two or more light-emitting diodes, hereinafter indicated as LED (Light Emitting Diode).

In one embodiment, a LED string 5 can be divided into a plurality of segments, each segment comprising a series connection of a plurality of LEDs.

In other words, two or more LEDs connected in series can be grouped in such a way as to form a group of LEDs and thus a LED string can be composed of two or more groups of LEDs.

Moreover, one or more groups (or segments) of LEDs can be in turn composed of the parallel connection of two or more series of LEDs.

The rectifier 3 comprises two input terminals adapted to receive a positive V_{AC}+ and a negative V_{AC}− alternating voltage and comprises an output terminal adapted to generate a rectified alternating voltage V_{RTF}, as a function of the positive V_{AC}+ and negative V_{AC}− alternating voltage.

For example, the alternating voltage has an effective value equal to 230 volts and the rectified alternating voltage V_{RTF} is equal to 325 volts.

In one embodiment, the rectifier 3 is implemented with a full wave diode bridge.

The current regulator 4 (of the direct drive type) is electrically connected with the rectifier 3 and with the LED string 5.

The current regulator 4 comprises an input terminal Ito adapted to receive the rectified alternating voltage V_{RTF} and comprises four input terminals It₁, It₂, It₃, I₄ electrically connected to four respective different portions of the LED string 5

The current regulator 4 has the function of regulating the value of the total current Iₛₜᵣ flowing across the LED string 5.

Moreover, the current regulator 4 is configured to regulate the value of the total current Iₛₜᵣ flowing across the LED string 5, in order to suitably vary the light intensity of the LED string 5, as a function of the value of a control signal S_ctrl.

In one embodiment, the current regulator 4 is an integrated circuit identified with the code ACS1404.

The LED string 5 comprises a first terminal connected to the rectified alternating voltage V_{RTF} and comprises a second terminal connected to the current regulator 4.

It should be observed that, more in general, it is possible to interpose further electronic components between the output of the rectifier 3 and the first terminal of the LED string 5.

In particular, the LED string 5 comprises the series connection of four or more LEDs 5-1, 5-2, 5-3, 5-4, wherein:
the anode of LED 5-1 is connected to the output terminal of the rectifier 3 and thus it is configured to receive the rectified alternating voltage V_{RTF};
the cathode of LED 5-1 is connected to the anode of LED 5-2 and to the channel 1 of the current regulator 4;
the cathode of LED 5-2 is connected to the anode of the LED 5-3 and to the channel 2 of the current regulator 4;
the cathode of LED 5-3 is connected to the anode of the LED 5-4 and to the channel 3 of the current regulator 4;
the cathode of LED 5-4 is connected to the channel 4 of the current regulator 4.

It can be observed that, more in general, each of the LEDs 5-1, 5-2, 5-3, 5-4 can be a series connection of two or more LEDs, that is, each series connection is a segment of the LED string 5.

The anti-flicker circuit 8 has the function of reducing any flicker of the light intensity generated by the LED string 5.

The anti-flicker circuit 8 is implemented for example with the set of a bias stage 8 (typically a voltage divider with two resistors), an electronic switch 6, a capacitor 7, which are connected as shown in FIGS. 1-3 of PCT application having publication number WO 2018/172980 A1.

The voltage converter 6 has the function of carrying out a voltage conversion from a first value to a second value smaller than the first value.

The voltage converter 6 thus comprises an input terminal adapted to receive the rectified alternating voltage V_{RTF} and comprises an output terminal adapted to generate a low DC current V3.3.

For example, the voltage converter 6 carries out the conversion of the rectified alternating voltage V_{RTF} having an effective value equal to 325 V into the low DC current V3.3 equal to 3.3 Volt.

The processing unit 7 has the function of suitably controlling the light intensity generated by the LED string 5, in order to optimise the energy consumption of the lamp 1 and with the purpose of satisfying the lighting needs of a determined area.

The processing unit 7 is for example a microprocessor or a microcontroller running an appropriate software program.

Alternatively, the processing unit 7 is a programmable electronic device (for example an FPGA).

In particular, the processing unit 7 is electrically connected to the current regulator 4 and comprises an output terminal adapted to generate the control signal S_ctrl to appropriately vary the light intensity of the LED string 5, by means of the control of the value of the current flowing across the LED string 5.

The transceiver 9 is electrically connected on one side to the antenna 10 (for example by means of an electric cable 11) and on the other side to the processing unit 7 (by means of an electric track on the printed circuit board 20).

The transceiver 9 has the function of modulating/demodulating the signals to generate/receive a radio signal in the frequency band comprised between 400 Mhz and 2.4 Ghz, in order to receive, from outside, commands for controlling the operation of the lamp 1 (for example, commands for switching on or off the LED string 5, commands for varying the intensity of the light beam generated by the LED string 5) and in order to externally transmit the monitoring information of the operation of the lamp 1 (for example, alarm messages regarding the operation of the lamp 1).

In particular, the transceiver 9 comprises a first input/output terminal adapted to receive the transmission/receiving signal S_rx_tx from the antenna 10 carrying the commands for controlling the operation of the lamp 1 and is adapted to transmit, towards the antenna 10, the transmission/receiving signal S_rx_tx carrying the monitoring information of the operation of the lamp 1.

The transceiver 9 further comprises a second input/output terminal adapted to receive the internal signal S_d from the processing unit 7, the internal signal S_d carrying the monitoring information of the operation of the lamp 1, and adapted to transmit to the processing unit 7 the internal signal S_d carrying the commands for controlling the operation of the lamp 1.

The transceiver 9 is configured to demodulate the transmission/receiving signal S_rx_tx and to generate therefrom the internal signal S_d carrying said commands for controlling the operation of the lamp 1; moreover, the transceiver 9 is configured to modulate the internal signal S_d and to generate therefrom the transmission/receiving signal S_rx_tx carrying the monitoring information of the operation of the lamp 1.

The antenna 10 is electrically connected to the transceiver 9 and has the function in transmission of converting the generated electric signal of the transmission/receiving signal S_rx_tx into an electromagnetic wave which propagates outside of the lamp 1, crossing the protection screen 1-2.

Moreover, the antenna 10 has the function in reception of converting the electromagnetic wave received from outside the lamp 1 via a radio signal S_r (i.e. a wireless signal) into an electric signal of the transmission/receiving signal S_rx_tx.

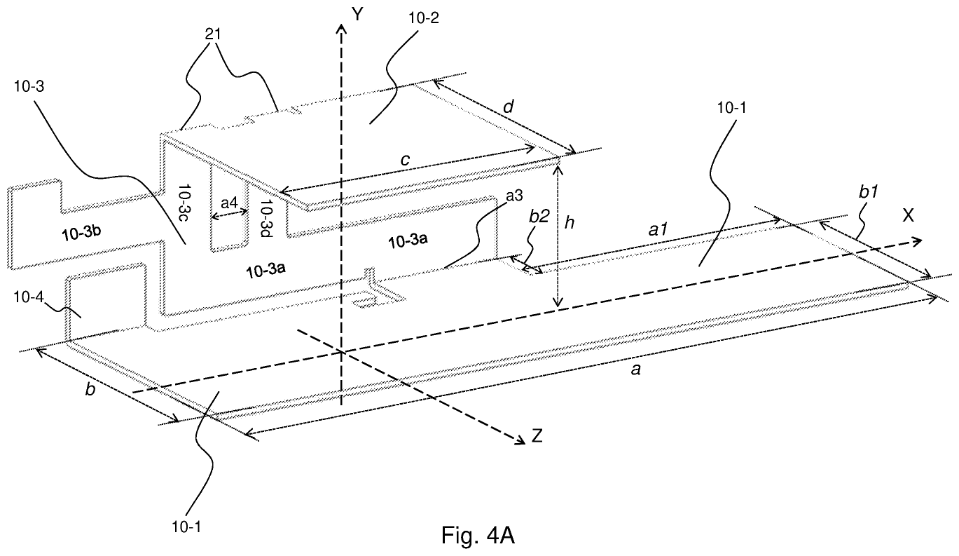

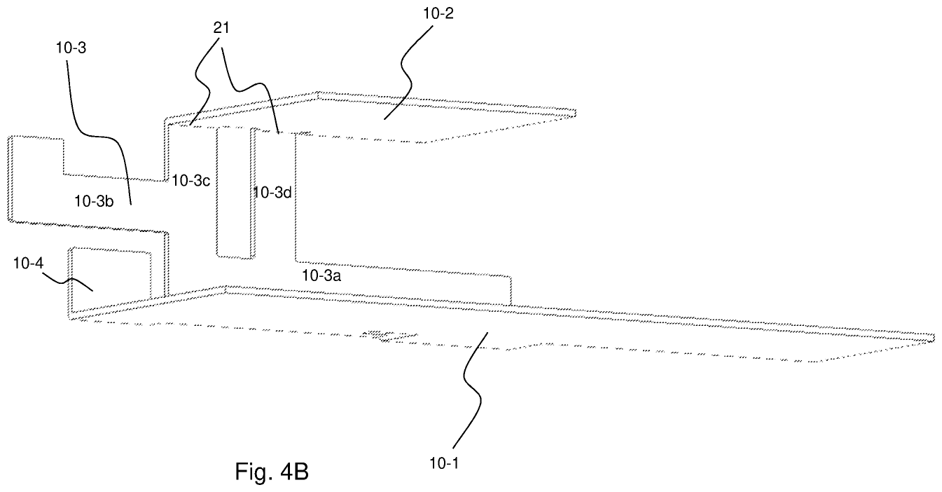

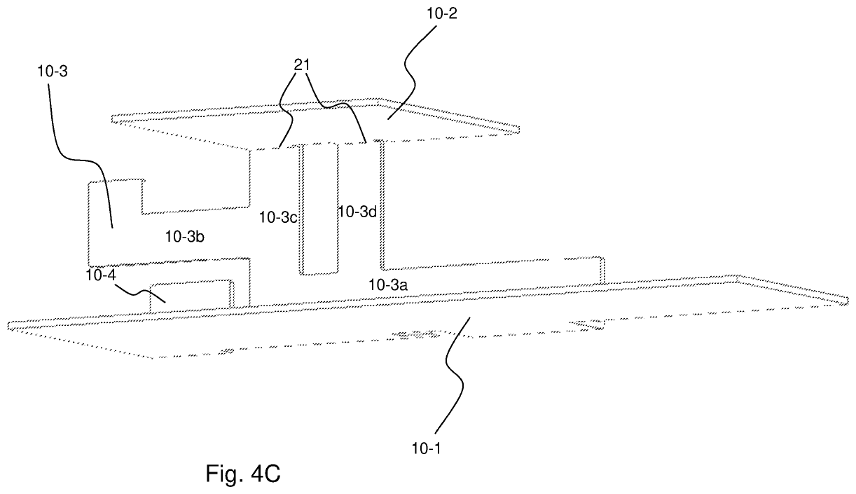

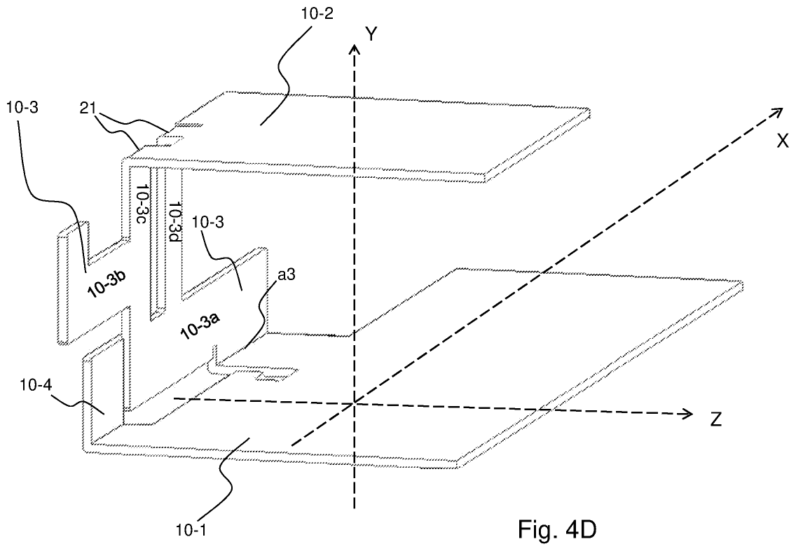

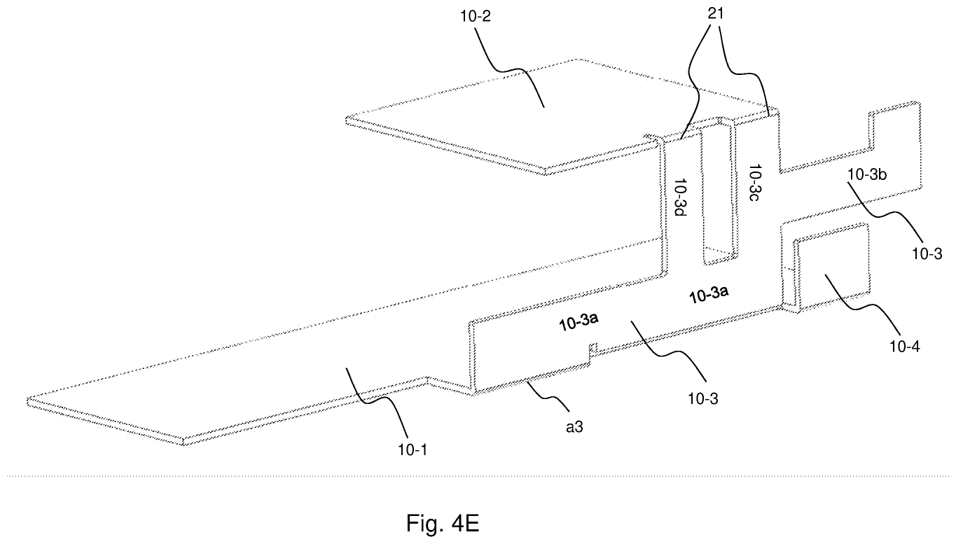

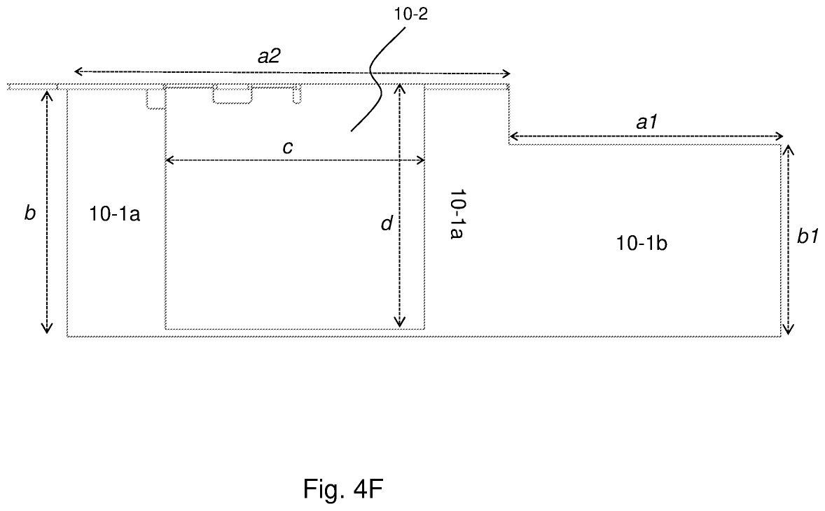

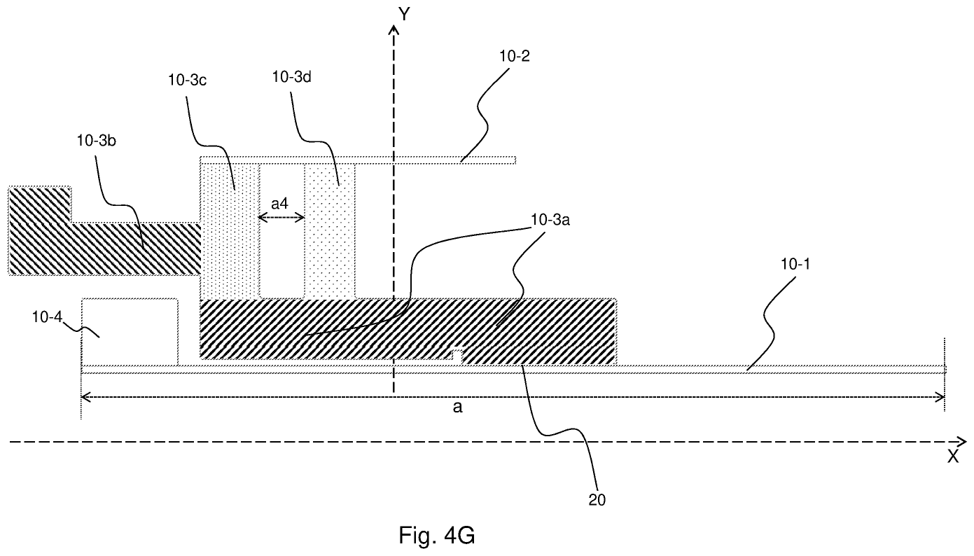

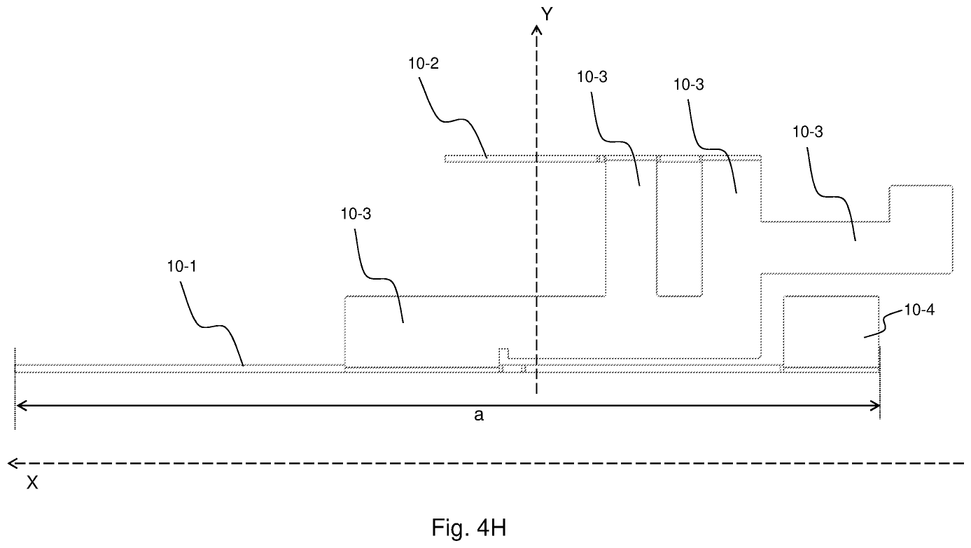

Advantageously, the antenna 10 is implemented with a special shape, illustrated in greater detail in the following with reference to FIGS. 4A-4D, 4E, 4F, 4G-H.

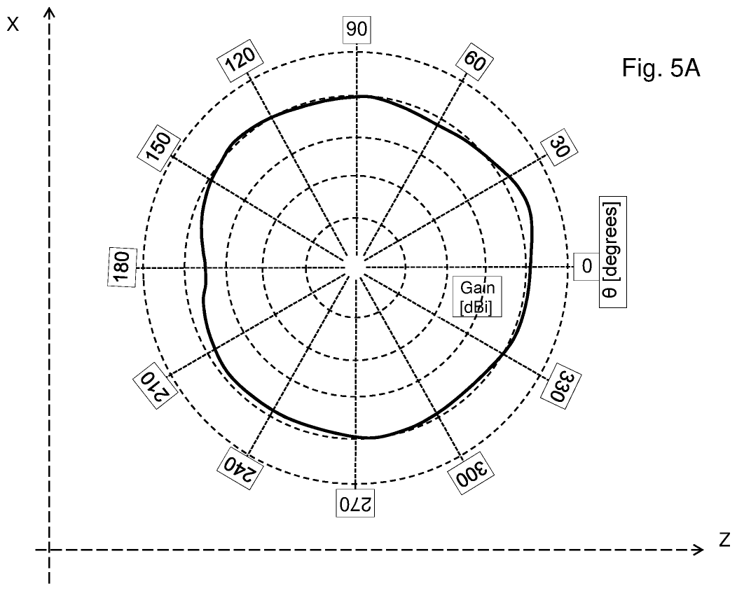

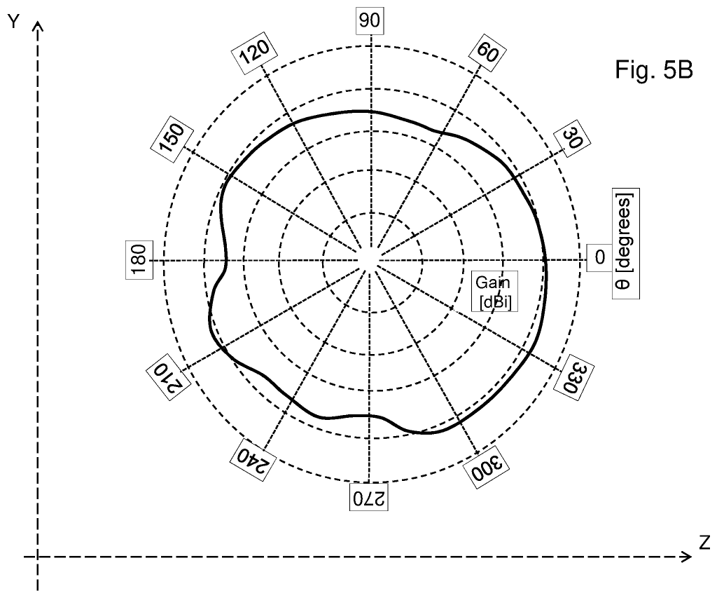

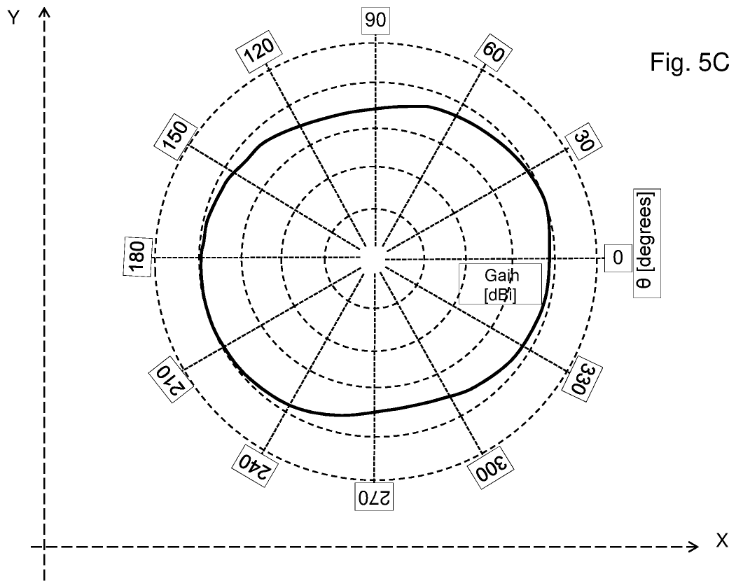

Said special shape allows—possibly together with the surface 20-1 of the printed circuit board 20 on which the antenna 10 is mounted—obtaining a radiation diagram which is substantially circular in the three sections of the three planes (X, Z), (Y, Z), (Y, X) of the reference system (X, Y, Z) associated to the antenna 10 (see FIGS. 5A-C), thus maximising the power of the electromagnetic waves received/transmitted from/towards the outside of the lamp 1 along the whole 360° angle about the antenna 10: this allows connecting a lamp 1 via radio with various other surrounding and similar lamps positioned around it in any angular position.

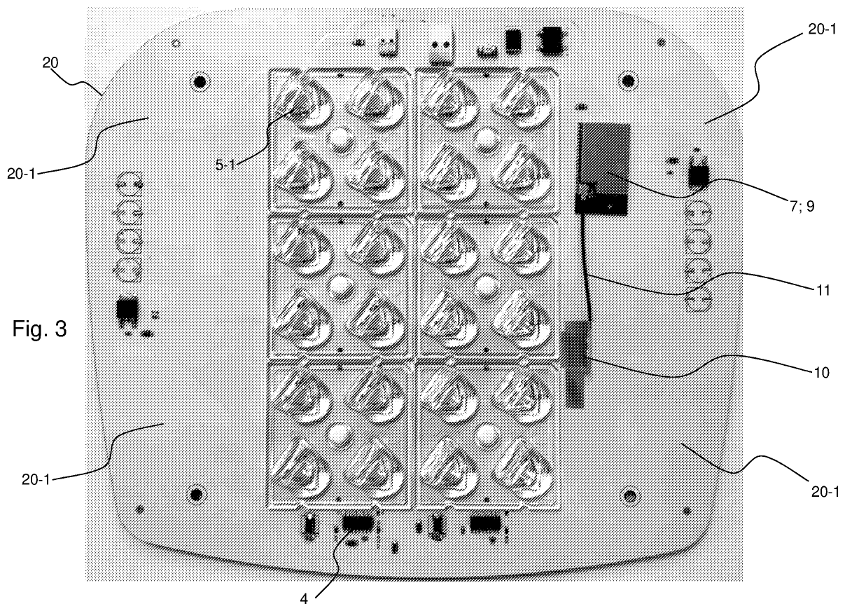

With reference to FIG. 3, it shows a single printed circuit board 20 positioned inside the casing of the lamp 1 and on which the electronic components are mounted.

The board 20 is for example made of FR4 material.

FIG. 3 shows that the board 20 comprises a mounting surface which is flat and on which are mounted the LEDs of the string 5 (for simplicity's sake indicated by one LED 5-1 only), the antenna 10, the processing unit 7, the transceiver 9 and the power system, wherein the processing unit 7 and the transceiver 9 are implemented with a single electronic component.

It can be observed that the board 20 comprises a metallic layer 20-1 (for example made of aluminium) which extends substantially over the whole flat surface of the board 20 and which defines a ground surface, i.e. a reference ground voltage (i.e. 0 volts).

Note that more generally it is sufficient for there to be present a flat portion of the mounting surface of the board 20 having the metallic layer, so that the antenna 10 is mounted inside said flat portion covered by the metallic layer.

The antenna 10 is electrically connected to the transceiver 9 by means of an electric connecting cable 11 composed of an internal conductor and an external conductor (for example a metallic braid), wherein the two conductors are electrically separated from each other by an insulating material.

A first end of the internal conductor of the cable 11 is electrically connected to a first input/output terminal of the transceiver 9; a second end of the internal conductor of the cable 11 is electrically connected to the antenna 10, in particular to an upper lamination 10-2 which will be illustrated in greater detail in the following.

Moreover, a first end of the external conductor is electrically connected to a ground terminal of the transceiver 9; a second end of the external conductor is electrically connected to a ground reference of the antenna 10, in particular to a lower lamination 10-1 which will be illustrated in greater detail in the following.

Alternatively, the antenna 10 is electrically connected to the transceiver 9 by means of a track (appropriately defined in length and shape) of the printed circuit board 20.

It can be observed in FIG. 3 that the antenna 10 is mounted in proximity of a pair of LEDs, so as to exploit the passage of the lamp 1 towards the outside allowed for the electromagnetic waves by the protection screen 1-2.

More in general, a plurality of light emitting diodes is mounted on a portion of the mounting surface of the board located in correspondence of the opening of the body of the casing of the lamp 1 (and therefore in correspondence of the protection screen 1-2) and in this case the antenna 10 is mounted in proximity of a perimeter portion of said portion of the surface comprising the plurality of LEDs.

FIGS. 4A-D, 4E, 4F, 4G-H show in greater detail the antenna 10 mounted inside the casing of the lamp 1 and in proximity of the protection screen 1-2.

It can be observed that the antenna 10 is formed by a lower lamination 10-1 and by an upper lamination 10-2 each having a flat surface, and are parallel to one another.

The flat surface of the upper lamination 10-2 is parallel to the flat surface 20-1 of the printed circuit board on which the electronic components are mounted.

The laminations 10-1, 10-2 are separated from one another by a distance h which is a function of the frequency band at which the antenna 10 operates.

For example, the distance h is equal to 9 millimetres [mm] in a case where the antenna operates to transmit/receive a radio signal in the band comprised between 800 Mhz and 2.4 Ghz.

The upper lamination 10-2 is partly overlapped (in a top view of the antenna 10) on the lower lamination 10-1, as shown in FIG. 4F.

In fact, in transmission the lower lamination 10-1 has the function of concentrating the electromagnetic waves towards the upper lamination 10-2, which is thus able to transmit power towards any angular direction in space, i.e. along an entire 360° angle of the sections of the radiation diagram of the antenna 20, as illustrated in FIGS. 5A-C.

Viceversa, in reception the lower lamination 10-1 has a reflector function which concentrates the received electromagnetic waves towards the upper lamination 10-2, which is thus able to receive power from any angular direction in space around the antenna 10.

The laminations 10-1, 10-2 are made of a metallic material and thus are sufficiently rigid.

The lower lamination 10-1 is fixed to the printed circuit board 20 (for example by means of a glue) and constitutes the ground reference of the antenna 20.

The upper lamination 10-2 is the positive terminal of the antenna 10 and is such to carry out the transmission/reception of power towards/from the environment surrounding the lamp post on which the lamp 1 is mounted, by means of a radio signal S_r.

Moreover, the upper lamination 10-2 is electrically connected to the first input/output terminal of the transceiver 9, in particular by means of the internal conductor of the electric cable 11.

Advantageously, the metallic layer 20-1 of the printed circuit board contributes to realising (together with the lower lamination 10-1) the reflection function of the received electromagnetic waves (from outside the lamp 1 by means of the radio signal S_r) towards the upper lamination 10-2, in order to obtain a radiation diagram of the antenna 20 which transmits and receives power in all spatial directions.

In particular, the lower lamination 10-1 is a metallic sheet having a surface with a substantially rectangular shape and a thickness that is much smaller than the dimensions of the sides of the rectangular surface, but sufficient to obtain the lower lamination 10-1 with a good degree of rigidity.

For example, the longer side a of the rectangular surface of the lower lamination 10-1 is equal to 38.0 mm, while the shorter side b is equal to 13.0 mm and the thickness is equal to 0.3 mm.

Likewise, the upper lamination 10-2 is a metallic sheet having a surface with a substantially rectangular shape and a thickness that is much smaller than the dimensions of the sides of the rectangular surface, but sufficient to obtain the upper lamination 10-2 with a good degree of rigidity.

For example, the longer side c of the rectangular surface of the upper lamination 10.2 is equal to 13.8 mm, while the smaller sided is equal to 13.2 mm and the thickness is equal to 0.3 mm.

In one embodiment, the lower lamination 10-1 comprises two rectangular portions 10-1a, 10-1b side-by-side to each other along the respective shorter sides and respectively defined by sides having dimensions (a2, b) and (a1, b1) (see FIGS. 4A and 4F), so that the upper lamination 10-2 is completely overlapped (in a top view) on the portion 10-1a of the lower lamination (see the top view of FIG. 4F) and so that the remaining non overlapping lower portion 10-1a is positioned (in a top view) laterally to both sides d of the upper portion 10-1, wherein a1+a2=a, b1 is smaller than b, c is smaller than a2.

For example, the two rectangular portions have the following dimensions:
a1=14.5 mm;
a2=23.4 mm;
b1=10.4 mm;
b=13.0 mm;
b=13.85 mm.

It is defined (see FIGS. 4A and 4D) a Cartesian reference system (X, Y, Z) for antenna 10 in which the axes X, Y and Z are defined as follows:
axis X is defined by the main extension direction (side a) of the lower lamination 10-1;
axis Z is defined by the secondary extension direction (side b) of the lower lamination 10-1;
axis Y is defined by the direction of the thickness of the lower lamination 10-1, i.e. the perpendicular to the flat surface defined by the lower lamination 10-1.

The plane (X, Y) corresponds to the opening in which the protection screen 1-2 of the lamp 1 is housed.

Therefore the lower lamination 10-1 has the main extension along the axis X and has the secondary extension along the axis Z.

Likewise, the upper lamination 10-2 thus has the main extension along axis X and has the secondary extension along axis Z, i.e. the main extension of the upper lamination 10-2 is parallel to the main extension of the lower lamination 10-1 and the secondary extension of the upper lamination 10-2 is parallel to the secondary extension of the lower lamination 10-1.

The antenna 10 further comprises a support element 10-3 made of a metallic material having the function of supporting the upper lamination 10-2 with respect to the lower lamination 10-1 or with respect to the printed circuit board 20.

In particular, the support element 10-3 mechanically connects the lower lamination 10-1 to the upper lamination 10-2, by means of at least a part of a lower edge thereof.

The support element 10-3 has a substantially flat surface having a main extension direction which is parallel to the main extension direction of the lower lamination 10-1 (side a) and of the upper lamination 10-2 (side c) and has a secondary extension direction which is parallel to the secondary extension direction of the lower lamination 10-1 (side b) and of the upper lamination 10-2 (side d), so that the secondary extension direction of the support element 10-3 is perpendicular to the surface of the lower lamination 10-1 and of the upper lamination 10-2.

The support element 10-3 has a lower edge a3 (see FIGS. 4A, 4D, 4E, 4G) which is connected to at least a part of an edge of the lower lamination 10-1 along the main extension direction thereof, in particular with a part of the edge of the portion 10-1a along the side a2.

Moreover, the support element 10-3 has at least one upper edge 21 (see FIGS. 4A, 4B, 4C, 4D, 4E) which is connected to at least one edge of the upper lamination 10-2 along the main extension direction thereof.

More in particular, the support element 10-3 is also a metallic lamination that comprises four portions 10-3a, 10-3b, 10-3c, 10-3d (see FIG. 4G) defined as follows:
the portion 10-3a (broken line towards the right in FIG. 4G) has a substantially rectangular shape having a main extension direction parallel to the main extension direction of the laminations 10-1, 10-2 (thus the main extension direction of the portion 10-3a is parallel to the axis X) and having a secondary extension direction that is perpendicular to the surface of the laminations 10-1, 10-2 (thus the secondary extension direction of the portion 10-3a is parallel to the axis Y);
the portion 10-3b (broken line towards the left in FIG. 4G) has an L shape having a main extension direction parallel to the main extension direction of the laminations 10-1, 10-2 (thus the main extension direction of the portion 10-3a is parallel to the axis X) and having a secondary extension direction that is perpendicular to the surface of the laminations 10-1, 10-2 (thus the secondary extension direction of the portion 10-3b is parallel to the axis Y);
the portion 10-3c (dotted line with a greater density in FIG. 4G) has a substantially rectangular shape having a main extension direction that is perpendicular to the surface of the laminations 10-1, 10-2 (thus the main extension direction of the portion 10-3c is parallel to the axis Y) and having a secondary extension direction that is parallel to the main extension direction of the laminations 10-1, 10-2 (thus the secondary extension direction of the portion 10-3c is parallel to the axis Y);
the portion 10-3d (dotted line with a lesser density in FIG. 4G) has a substantially rectangular shape having a main extension direction that is perpendicular to the surface of the laminations 10-1, 10-2 (thus the main extension direction of the portion 10-3d is parallel to the axis Y) and having a secondary extension direction that is parallel to the main extension direction of the laminations 10-1, 10-2 (thus the secondary extension direction of the portion 10-3d is parallel to the axis X).

The portions 10-3c, 10-3d are interposed between the portions 10-3a and 10-3b.

The lower longer side of the substantially rectangular shape of the portion 10-3a comprises a part that defines the lower edge a3 which is connected to a part of the edge of the lower lamination 10-1 and comprises a remaining part that is not connected to the lower lamination.

The upper longer side of the substantially rectangular shape of the portion 10-3a comprises a first part connected to the lower shorter side of the portion 10-3c, comprises a second part connected to the lower shorter side of the portion 10-3d, comprises a third part connected to the lower shorter side of the portion 10-3c and comprises a remaining fourth part that is not connected either to the portions 10-3c, 10-3d, 10-3b or to the upper lamination 10-2.

The upper shorter side of the portion 10-3c is connected to a part of the longer side c of the upper lamination 10-2 and the upper shorter side of the portion 10-3d is connected to another part of the same longer side c of the upper lamination 10-2.

The portion 10-3b comprises an edge connected to a part of the left longer side of the portion 10-3b, while the remaining edges of the portion 10-3b are not connected.

The dimensions of the shorter side of the rectangular shape of the portion 10-3d are slightly smaller than the dimensions of the shorter side of the rectangular shape of the portion 10-3c.

For example, the shorter side of the portion 10-3c is equal to 2.6 mm and the shorter side of the portion 10-3d is equal to 2.1 mm.

The distance a4 between the adjacent longer sides of the portions 10-3c and 10-3d is for example equal to 2 mm.

In case wherein the antenna 10 is electrically connected to the transceiver 9 by means of an electric cable 11 composed of the internal conductor and of the external conductor (for example a metal braid), the portion 10-3a of the lamination 10-3 is electrically connected to an end of the internal conductor, thus carrying out the electrical connection of the upper lamination 10-2 of the antenna 10 to the input/output terminal of the transceiver 9 via the portion 10-3a

The antenna 10 further comprises a connecting lamination 10-4 having a rectangular shape (for example, sides having dimensions of 3 mm and 4.0 mm), which is connected to the end of the lower lamination 10-1, in particular with a part of the longer side of the portion 10-1a.

In particular, the connecting lamination 10-4 has the longer side parallel to the longer side a of the lower lamination 10-1 (and thus it is parallel to the direction of axis X) and has the shorter side perpendicular to the surface of the laminations 10-1, 10-2 (and thus it is parallel to the direction of axis Y).

In case wherein the antenna 10 is electrically connected to the transceiver 9 by means of an electric cable 11 composed of an internal conductor and an external conductor (for example a metal braid), the connecting lamination 10-4 is electrically connected to an end of the external conductor (for example the metal braid) and thus to the ground reference of the antenna 10, thus carrying out the electrical connection of the lower lamination 10-1 to the ground reference via the connecting lamination 10-4.

Note that the presence of the lower lamination 10-1 is not essential for the purposes of the operation of the antenna 10, i.e. it is possible that only the upper lamination 10-2 is fixed directly to the metallic layer 20-1 of the board 20 by means of the support element 10-3: in this case the upper lamination 10-2 is fixed (by means of the support element 10-3) to the metallic layer 20-1 of the board 20 by welding or by other fixing means and the reflection function is implemented with the portion of the metallic layer 20-1 of the board 20 which is positioned in proximity of the upper lamination 10-2 surrounding it.

With reference to FIGS. 5A, 5B, 5C, they show using a continuous line three sections of the radiation diagram of the antenna 10, respectively in the three planes (Z, X), (Z, Y), (X, Y) of the space (X, Y, Z), wherein the axes X, Y, Z are orientated as illustrated previously in FIGS. 4A, 4D, 4G, 4H.

In particular, the three sections of the radiation diagram show the gain value (measured in dBi) of the antenna 10 as the angular direction (measured in degrees) changes in the three planes (Z, X), (Z, Y), (X, Y).

It can be observed that the three radiation diagrams have a substantially circular shape, i.e. the gain of the antenna in each of the three planes is substantially constant as the whole 360° angle changes: therefore the radiation diagram of the antenna 10 in the space (X, Y, Z) has a shape alike to a sphere, i.e. the antenna 10 can transmit/receive power in/from all directions of the space.

Therefore the antenna 10 is able to transmit/receive power towards/from any angular direction in the surrounding space: this allows connecting a lamp post 1 via radio with various other surrounding lamp posts positioned around it in any angular position.

The antenna 10 has an average gain equal to about 4.2 dBi when using a board 20 made of FR4 material and equal to 4.7 dBi when using a board 20 with an aluminium substrate, even when varying the angle in the plane (X, Y) which corresponds to the opening in which the protection screen 1-2 of the lamp 1 is housed.

Note that the disclosure is not limited to a lamp for public lighting (typically roads), but it can also be used for private lighting in commercial, office and industrial environments.

Note also that the disclosure is not limited to a lamp with LED technology in order to generate the light beam, but other technologies for generating the light beam can also be used.

1.-10. (canceled)

11. A lamp for public, industrial or commercial lighting, comprising:
a casing having a metallic body provided with an opening adapted to allow the passage of a light beam;
a protection screen adapted to close the opening and at least partially transparent with respect to the light beam;
a printed circuit board comprising a mounting surface on which are mounted at least one light beam source, a processing unit, a transceiver of wireless signals connected to the processing unit, an antenna connected to the transceiver and a power supply circuit;
wherein the printed circuit board is housed entirely inside the casing,
the mounting surface comprising at least one flat portion having a metallic layer and inside which the antenna is mounted,
wherein the antenna is mounted on the board such that the antenna is positioned near the opening of the body of the casing, in order to allow the electromagnetic wave carried by the wireless signal to pass through the protection screen.

12. The lamp according to claim 11, wherein the antenna is positioned near a perimeter portion of the protection screen.

13. The lamp according to claim 11, wherein the antenna comprises:
a metallic lamination having a substantially rectangular shape and a flat surface parallel to the flat portion of the mounting surface of the printed circuit board, the two flat surfaces being separated by a defined distance which depends on the value of the frequency of the electromagnetic wave carried by the wireless signal;
a support element of said lamination with respect to the mounting surface of the board;
wherein at least the flat portion of the mounting surface of the board near said lamination is configured to reflect towards said lamination the electromagnetic waves received by means of the wireless signal.

14. The lamp according to claim 12, wherein the antenna comprises:
a metallic lamination having a substantially rectangular shape and a flat surface parallel to the flat portion of the mounting surface of the printed circuit board, the two flat surfaces being separated by a defined distance which depends on the value of the frequency of the electromagnetic wave carried by the wireless signal;
a support element of said lamination with respect to the mounting surface of the board; wherein at least the flat portion of the mounting surface of the board near said lamination is configured to reflect towards said lamination the electromagnetic waves received by means of the wireless signal.

15. The lamp according to claim 13, wherein the antenna comprises a further metallic lamination mounted on the printed circuit board such to be positioned in proximity of the opening of the body of the casing,
said further lamination having a flat surface comprising a portion that is parallel to the flat surface of said lamination and is separated from it by said defined distance,
and wherein at least one portion of the flat surface of said further lamination is configured to reflect towards said lamination the electromagnetic waves received by means of the wireless signal.

16. The lamp according to claim 14, wherein the antenna comprises a further metallic lamination mounted on the printed circuit board such to be positioned in proximity of the opening of the body of the casing,
said further lamination having a flat surface comprising a portion that is parallel to the flat surface of said lamination and is separated from it by said defined distance,
and wherein at least one portion of the flat surface of said further lamination is configured to reflect towards said lamination the electromagnetic waves received by means of the wireless signal.

17. The lamp according to claim 15, said further lamination comprising two rectangular portions adjacent to each other along the respective shorter sides, wherein said lamination is entirely overlapped only on one of the two portions of the further lamination.

18. The lamp according to claim 16, said further lamination comprising two rectangular portions adjacent to each other along the respective shorter sides, wherein said lamination is entirely overlapped only on one of the two portions of the further lamination.

19. The lamp according to claim 13, the antenna further comprising a connecting lamination having a rectangular shape and connected to a terminal portion of said further lamination,
the lamp further comprising an electric cable adapted to connect the antenna to the transceiver, the electric cable comprising an internal and external conductor which are electrically separated from each other, wherein:
the internal conductor has a first end electrically connected to an input/output terminal of the transceiver and a second end electrically connected to said lamination;
the external conductor has a first end electrically connected to a ground terminal of the transceiver and a second end electrically connected to said connecting lamination.

20. The lamp according to claim 14, the antenna further comprising a connecting lamination having a rectangular shape and connected to a terminal portion of said further lamination,
the lamp further comprising an electric cable adapted to connect the antenna to the transceiver, the electric cable comprising an internal and external conductor which are electrically separated from each other, wherein:
the internal conductor has a first end electrically connected to an input/output terminal of the transceiver and a second end electrically connected to said lamination;
the external conductor has a first end electrically connected to a ground terminal of the transceiver and a second end electrically connected to said connecting lamination.

21. The lamp according claim 15, the antenna further comprising a connecting lamination having a rectangular shape and connected to a terminal portion of said further lamination,
the lamp further comprising an electric cable adapted to connect the antenna to the transceiver, the electric cable comprising an internal and external conductor which are electrically separated from each other, wherein:
the internal conductor has a first end electrically connected to an input/output terminal of the transceiver and a second end electrically connected to said lamination;
the external conductor has a first end electrically connected to a ground terminal of the transceiver and a second end electrically connected to said connecting lamination.

22. The lamp according claim 17, the antenna further comprising a connecting lamination having a rectangular shape and connected to a terminal portion of said further lamination,
the lamp further comprising an electric cable adapted to connect the antenna to the transceiver, the electric cable comprising an internal and external conductor which are electrically separated from each other, wherein:
the internal conductor has a first end electrically connected to an input/output terminal of the transceiver and a second end electrically connected to said lamination;
the external conductor has a first end electrically connected to a ground terminal of the transceiver and a second end electrically connected to said connecting lamination.

23. The lamp according to claim 19, wherein the support element is a metallic lamination comprising a substantially rectangular portion electrically connected to the second end of the internal conductor of the electric cable.

24. The lamp according to claim 11, wherein the at least one light source comprises a plurality of light emitting diodes positioned on a portion of the mounting surface of the board and in correspondence of the protection glass, and wherein the antenna is mounted in proximity of a perimeter portion of said portion of the surface comprising the plurality of light emitting diodes.

25. The lamp according to claim 14, wherein:
the sides of said rectangular lamination are equal to about 13.8 millimetres and 13.3 millimetres;
the sides of said further lamination are equal to about 38.0 millimetres and 13.0 millimetres;
the distance between the surfaces of the two laminations is equal to approximately 9 millimetres;
wherein the band of the wireless signal is comprised within the range of frequencies between 800 MHz and 2.4 GHz.

26. A lighting system comprising a plurality of lamps, each lamp comprising:
a casing having a metallic body provided with an opening adapted to allow the passage of a light beam;
a protection screen adapted to close the opening and at least partially transparent with respect to the light beam;
a printed circuit board comprising a mounting surface on which are mounted at least one light beam source, a processing unit, a transceiver of wireless signals connected to the processing unit, an antenna connected to the transceiver and a power supply circuit;
wherein the printed circuit board is housed entirely inside the casing,
the mounting surface comprising at least one flat portion having a metallic layer and inside which the antenna is mounted,
wherein the antenna is mounted on the board such that the antenna is positioned near the opening of the body of the casing, in order to allow the electromagnetic wave carried by the wireless signal to pass through the protection screen,
wherein each lamp of said plurality is configured to exchange information via radio with at least one other lamp of said plurality of lamps.

27. The lighting system according to claim 26, wherein the antenna is positioned near a perimeter portion of the protection screen.

28. The lighting system according to claim 26, wherein the antenna comprises:
a metallic lamination having a substantially rectangular shape and a flat surface parallel to the flat portion of the mounting surface of the printed circuit board, the two flat surfaces being separated by a defined distance which depends on the value of the frequency of the electromagnetic wave carried by the wireless signal;
a support element of said lamination with respect to the mounting surface of the board;
wherein at least the flat portion of the mounting surface of the board near said lamination is configured to reflect towards said lamination the electromagnetic waves received by means of the wireless signal.

29. The lighting system according to claim 27, wherein the antenna comprises:
a metallic lamination having a substantially rectangular shape and a flat surface parallel to the flat portion of the mounting surface of the printed circuit board, the two flat surfaces being separated by a defined distance which depends on the value of the frequency of the electromagnetic wave carried by the wireless signal;
a support element of said lamination with respect to the mounting surface of the board; wherein at least the flat portion of the mounting surface of the board near said lamination is configured to reflect towards said lamination the electromagnetic waves received by means of the wireless signal.

30. The lighting system according to claim 28, wherein the antenna comprises a further metallic lamination mounted on the printed circuit board such to be positioned in proximity of the opening of the body of the casing,
said further lamination having a flat surface comprising a portion that is parallel to the flat surface of said lamination and is separated from it by said defined distance,
and wherein at least one portion of the flat surface of said further lamination is configured to reflect towards said lamination the electromagnetic waves received by means of the wireless signal.
